(19) United States
(12) Patent Application Publication
(10) Pub. No.: US 2016/0264487 A1
(43) Pub. Date: Sep. 15, 2016

(54) SUSTAINED RELEASE OF NUTRIENTS USING SOLIDS FROM LIGNOCELLULOSE FERMENTATION

(71) Applicant: E I DU PONT DE NEMOURS AND COMPANY, Wilmington, DE (US)

(72) Inventors: KATRINA KRATZ, Chadds Ford, PA (US); KAYLEIGH J. FERGUSON, Greenville, DE (US)

(21) Appl. No.: 15/066,500

(22) Filed: Mar. 10, 2016

Related U.S. Application Data
(60) Provisional application No. 62/132,061, filed on Mar. 12, 2015.

(51) Int. Cl. C05G 3/00; C05C 9/00

(52) U.S. Cl. CPC C05G 3/0047; C05C 9/00; C05G 3/0094; C05G 3/0029

(57) ABSTRACT

Disclosed herein are a composition, process and method to provide sustained release of nutrients to plants. Filter cake, which is a co-product of a lignocellulosic biomass fermentation process, is included in a matrix to prevent leaching of plant nutrients and provide sustained release of nutrients over time to plants.

### CROSS-REFERENCE TO RELATED APPLICATIONS

This application claims the benefit of priority to U.S. Provisional Patent Application No. 62/132,061, filed on Mar. 12, 2015, which is incorporated by reference in its entirety.

### FIELD

This disclosure relates to the field of providing sustained release of bio-derived nutrient supplements to plants.

### BACKGROUND

Sustained release of nutrients and/or fertilizers is becoming increasingly popular for crop production in an effort to improve plant macronutrients (nitrogen, phosphorus and potassium) uptake efficiency and to reduce their leaching and nitrification. Therefore, plant macronutrients are needed to be applied externally through fertilizers. In some cases binders are used to immobilize plant macronutrients within the binder's matrix to prevent their rapid release and/or leaching into the soil.

Successful improvement of nutrient uptake efficiency requires matching nutrient release with its demand by the plant. For example, at mid-season the amount of nitrogen available to plants can be depleted due to the nitrification process and leaching. Thus, during this period the amount of nitrogen required for a plant can be at highest levels. In this case delivery of nutrients, e.g., urea and ammonia, at mid-season can increase the crop's yield. Thus, there is a need for an economical delivery system that protects reduced forms of nitrogen from nitrification and leaching in the beginning of the season and then releases the nitrogen at mid-season.

### SUMMARY

In one aspect, the disclosure relates to a nutrient delivery composition comprising:
a) lignocellulosic filter cake;
b) one or more plant nutrients; and
c) optionally one or more additives.

In one aspect the nutrient delivery system further comprises at least one polymer forming a plant nutrient matrix.

In another aspect, the disclosure relates to a process for providing a plant nutrient delivery system comprising:
a) contacting lignocellulosic filter cake, one or more plant nutrients, and optionally, one or more additives, wherein a nutrient mixture is prepared; and
b) forming the nutrient mixture into a shape or form that can deliver nutrients to plants;
wherein a nutrient delivery system is prepared.

In another aspect, the disclosure relates to a process of providing sustained release of plant nutrients in the soil comprising:
a) providing the plant nutrient matrix disclosed above;
b) adding said plant nutrient matrix to soil under conditions whereby sustained release of nutrients over time is provided.

### DESCRIPTION OF FIGURES

FIG. 1 depicts a graph of urea release from filter cake (FC) plant nutrient matrix pellets over several weeks. Symbols used in the graph are: Squares (□) indicate 75% urea/25% FC ; triangles (Δ) indicate 50% urea/50% FC; circles (◯) indicate 25% urea/75% FC.

### DETAILED DESCRIPTION

It is the object of this disclosure to provide compositions and processes for providing sustained release of macronutrients (N, P, and K) and additionally of micronutrients to plants while preventing their leaching into the environment. In the instant disclosure filter cake, which is one of the co-products of a lignocellulosic biomass fermentation process, is used to provide a matrix to entrap plant nutrients to allow their sustained release over time and to provide such nutrients when required by plants.

### Definitions

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” modifying the quantity of an ingredient or reactant of the disclosure employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The term “fermentable sugar” refers to oligosaccharides and monosaccharides that can be used as a carbon source by a microorganism in a fermentation process.

The term “lignocellulosic” refers to a composition comprising both lignin and cellulose. Lignocellulosic material may also comprise hemicellulose.

The term “cellulosic” refers to a composition comprising cellulose and additional components, including hem icellulose.

The term “saccharification” refers to the production of fermentable sugars from polysaccharides.

The term “pretreated biomass” means biomass that has been subjected to pretreatment prior to saccharification. The pretreatment may take the form of physical, thermal or chemical means and combinations thereof.

The term “lignocellulosic biomass hydrolysate” refers to the product resulting from saccharification of lignocellulosic biomass. The biomass may also be pretreated or pre-processed prior to saccharification.

The term “lignocellulosic biomass hydrolysate fermentation broth” is broth containing product resulting from biocatalyst growth and production in a medium comprising lignocellulosic biomass hydrolysate. This broth includes components of lignocellulosic biomass hydrolysate that are not consumed by the biocatalyst, as well as the biocatalyst itself and product made by the biocatalyst.

The term “slurry” refers to a mixture of insoluble material and a liquid. A slurry may also contain a high level of dissolved solids. Examples of slurries include a saccharification broth, a fermentation broth, and a stillage.

The term “whole stillage” refers to the bottoms of a distillation. The whole stillage contains the high boilers and any solids of a distillation feed stream. Whole stillage is a type of depleted broth.

The term “thin stillage” refers to a liquid fraction resulting from solid/liquid separation of a whole stillage, fermentation broth, or product depleted fermentation broth.

The term “product depleted broth” or “depleted broth” refers herein to a lignocellulosic biomass hydrolysate fermentation broth after removal of a product stream.

The term “syrup” means a concentrated product produced from the removal of water, generally by evaporation, from thin stillage.

The term “target product” refers to any product that is produced by a microbial production host cell in a fermentation process. Target products may be the result of genetically engineered enzymatic pathways in host cells or may be produced by endogenous pathways. Typical target products include but are not limited to acids, alcohols, alkanes, alkenes, aromatics, aldehydes, ketones, biopolymers, proteins, peptides, amino acids, vitamins, antibiotics, and pharmaceuticals.

The term “fermentation” refers broadly to the use of a biocatalyst to produce a target product. Typically the biocatalyst grows in a fermentation broth utilizing a carbon source in the broth, and through its metabolism produces a target product.

The term “lignocellulosic biomass” refers to any lignocellulosic material and includes materials comprising cellulose, hemicellulose, lignin, starch, oligosaccharides and/or monosaccharides. Biomass can also comprise additional components, such as protein and/or lipid. Biomass can be derived from a single source, or biomass can comprise a mixture derived from more than one source; for example, biomass could comprise a mixture of corn cobs and corn stover, or a mixture of grass and leaves. Lignocellulosic biomass includes, but is not limited to, bioenergy crops, agricultural residues, municipal solid waste, industrial solid waste, sludge from paper manufacture, yard waste, wood and forestry waste. Examples of biomass include, but are not limited to, corn cobs, crop residues such as corn husks, corn stover, grasses (including Miscanthus), wheat straw, barley straw, hay, rice straw, switchgrass, waste paper, sugar cane bagasse, sorghum material, soybean plant material, components obtained from milling of grains or from using grains in production processes (such as DDGS: dried distillers grains with solubles), trees, branches, roots, leaves, wood chips, sawdust, shrubs and bushes, vegetables, fruits, flowers, empty palm fruit bunch, and energy cane.

The term “energy cane” refers to sugar cane that is bred for use in energy production. It is selected for a higher percentage of fiber than sugar.

The term “Solids” refers to soluble solids and insoluble solids. Solids from a lignocellulosic fermentation process contain residue from the lignocellulosic biomass used to make hydrolysate medium.

“Volatiles” refers herein to components that will largely be vaporized in a process where heat is introduced. Volatile content is measured herein by establishing the loss in weight resulting from heating under rigidly controlled conditions to 950° C. (as in ASTM D-3175). Typical volatiles include, but are not limited to, hydrogen, oxygen, nitrogen, acetic acid, and some carbon and sulfur.

“Fixed carbon” refers herein to a calculated percentage made by summing the percent of moisture, percent of ash, and percent of volatile matter, and then subtracting that percent from 100.

“Ash” is the weight of the residue remaining after burning under controlled conditions according to ASTM D-3174.

“Sugars” as referred to in the lignocellulosic syrup composition means a total of monosaccharide and soluble oligosaccharides.

As used herein, “macronutrients” are any nitrogen (N), phosphorus (P), or potassium (K) containing substance which can deliver nutrition to the plant.

As used herein, “micronutrients” are substances that are required in small amounts for plant growth such as boron (B), calcium (Ca) chlorine (Cl), manganese (Mn), iron (Fe), zinc (Zn), copper (Cu), molybdenum (Mo) and selenium (Se). Hereafter, the term “nutrients” is used for both macro- and micro-nutrients.

As used here, “plant” is intended to refer to any part of a plant (e.g., roots, foliage, shoot) including trees, shrubbery, flowers, and grasses.

As used herein, “treating” is intended to refer to coating, wrapping, covering, layering, encrusting, sheathing and blanketing the mixture of the FC, nutrients and optional additives of the nutrient delivery system. Treating may include heating to seal the layer around the nutrient delivery system.

As used herein, “forming” is intended to refer to tableting, pressing, molding, shaping, compression rolling, granulating, and the like.

As used herein, “nutrient delivery system” refers to beads, tablets, granules, pellets and pills in any shape of form that can deliver nutrients to plants. As used herein, nutrient delivery system comprises lignocellulosic filter cake and plant nutrients and optionally any additives required for the specific plant.

As used herein, the term “layer” refers to a thickness of a polymer spread or covered over the surface of the nutrient delivery system. As used herein, the at least one polymer layer can cover from about 50% to about 99.5% of the nutrient delivery system. Alternatively, the at least one polymer layer can cover from about 75% to about 99.5% of the nutrient delivery system.

As used herein, “plant nutrient matrix” refers to a mixture comprising lignocellulosic filter cake, and any of plant micronutrients, plant macronutrients, additives and any other chemicals required to provide nutrients to plants comprising at least one layer of one or more polymers.

As used herein, “additive” refers to any material that can function as one or more fertilizers, one or more binders, one or more pesticides and mixtures thereof, that can be added to the plant nutrients.

As used herein, “sustained release” refers to release of any nutrients or additives over an extended period of time, such as between 3-12 months.

### Fermentation of Lgnocellulosic Biomass

The filter cake (FC) suitable for application in the instant disclosure is produced as a co-product from a process that uses lignocellulosic biomass as a source of fermentable sugars which are used as a carbon source for a biocatalyst. The biocatalyst uses the sugars in a fermentation process to produce a target product.

To produce fermentable sugars from lignocellulosic biomass, the biomass is treated to release sugars such as glucose, xylose, and arabinose from the polysaccharides of the biomass. Lignocellulosic biomass may be treated by any method known by one skilled in the art to produce fermentable sugars in a hydrolysate. Typically the biomass is pretreated using physical, thermal and/or chemical treatments, and saccharified enzymatically. Thermo-chemical pretreatment methods include steam explosion or methods of swelling the biomass to release sugars (see for example WO2010113129; WO2010113130). Chemical saccharification may also be used. Physical treatments such as these may be used for particle size reduction prior to further chemical treatment. Chemical treatments include base treatment such as with strong base (ammonia or NaOH), or acid treatment (U.S. Pat. No. 8,545,633; WO2012103220). In one embodiment the biomass is treated with ammonia (U.S. Pat. No. 7,932,063; U.S. Pat. No. 7,781,191; U.S. Pat. No. 7,998,713; U.S. Pat. No. 7,915,017). These treatments release polymeric sugars from the biomass. In one embodiment the pretreatment is a low ammonia pretreatment where biomass is contacted with an aqueous solution comprising ammonia to form a biomass-aqueous ammonia mixture where the ammonia concentration is sufficient to maintain alkaline pH of the biomass-aqueous ammonia mixture but is less than about 12 weight percent relative to dry weight of biomass, and where dry weight of biomass is at least about 15 weight percent solids relative to the weight of the biomass-aqueous ammonia mixture, as disclosed in U.S. Pat. No.7,932,063, which is herein incorporated by reference.

Saccharification, which converts polymeric sugars to monomeric sugars, may be either by enzymatic or chemical treatments. For example, the pretreated biomass is contacted with a saccharification enzyme consortium under suitable conditions to produce fermentable sugars. Prior to saccharification, the pretreated biomass can be brought to the desired moisture content and treated to alter the pH, composition or temperature such that the enzymes of the saccharification enzyme consortium will be active. The pH can be altered through the addition of acids in solid or liquid form. Alternatively, carbon dioxide (CO₂), which can be recovered from fermentation, can be utilized to lower the pH. For example, CO₂ can be collected from a fermenter and fed into the pretreatment product headspace in the flash tank or bubbled through the pretreated biomass if adequate liquid is present while monitoring the pH, until the desired pH is achieved. The temperature is brought to a temperature that is compatible with saccharification enzyme activity, as noted below. Typically suitable conditions can include temperature from about 40° C. to about 50° C. and pH between from about 4.8 to about 5.8.

Enzymatic saccharification of cellulosic or lignocellulosic biomass typically makes use of an enzyme composition or blend to break down cellulose and/or hemicellulose and to produce a hydrolysate containing sugars such as, for example, glucose, xylose, and arabinose. Saccharification enzymes are reviewed in Lynd, L. R., et al. (Microbiol. Mol. Biol. Rev., 66:506-577, 2002). At least one enzyme is used, and typically a saccharification enzyme blend is used that includes one or more glycosidases. Glycosidases hydrolyze the ether linkages of di-, oligo-, and polysaccharides and are found in the enzyme classification EC 3.2.1.x (Enzyme Nomenclature 1992, Academic Press, San Diego, Calif. with Supplement 1 (1993), Supplement 2 (1994), Supplement 3 (1995, Supplement 4 (1997) and Supplement 5 [in Eur. J. Biochem., 223:1-5, 1994; Eur. J. Biochem., 232:1-6, 1995; Eur. J. Biochem., 237:1-5, 1996; Eur. J. Biochem., 250:1-6, 1997; and Eur. J. Biochem., 264:610-650 1999, respectively]) of the general group “hydrolases” (EC 3.). Glycosidases useful in saccharification can be categorized by the biomass components they hydrolyze. Glycosidases useful in saccharification can include cellulose-hydrolyzing glycosidases (for example, cellulases, endoglucanases, exoglucanases, cellobiohydrolases, β-glucosidases), hem icellulose-hydrolyzing glycosidases (for example, xylanases, endoxylanases, exoxylanases, β-xylosidases, arabino-xylanases, mannases, galactases, pectinases, glucuronidases), and starch-hydrolyzing glycosidases (for example, amylases, α-amylases, β-amylases, glucoamylases, α-glucosidases, isoamylases). In addition, it can be useful to add other activities to the saccharification enzyme consortium such as peptidases (EC 3.4.x.y), lipases (EC 3.1.1.x and 3.1.4.x), ligninases (EC 1.11.1.x), or feruloyl esterases (EC 3.1.1.73) to promote the release of polysaccharides from other components of the biomass. It is known in the art that microorganisms that produce polysaccharide-hydrolyzing enzymes often exhibit an activity, such as a capacity to degrade cellulose, which is catalyzed by several enzymes or a group of enzymes having different substrate specificities. Thus, a “cellulase” from a microorganism can comprise a group of enzymes, one or more or all of which can contribute to the cellulose-degrading activity. Commercial or non-commercial enzyme preparations, such as cellulase, can comprise numerous enzymes depending on the purification scheme utilized to obtain the enzyme. Many glycosyl hydrolase enzymes and compositions thereof that are useful for saccharification are disclosed in WO 2011/038019 or WO 2012/125937, incorporated herein by reference. Additional enzymes for saccharification include, for example, glycosyl hydrolases that hydrolyze the glycosidic bond between two or more carbohydrates, or between a carbohydrate and a noncarbohydrate moiety.

Saccharification enzymes can be obtained commercially. Such enzymes include, for example, Spezyme® CP cellulase, Multifect® xylanase, Accelerase® 1500, Accellerase® DUET, and Accellerase® Trio™ (Dupont™/Gencor®, Wilmington, Del. ), and Novozyme-188 (Novozymes, 2880 Bagsvaerd, Denmark). In addition, saccharification enzymes can be provided as crude preparations of a cell extract or a whole cell broth. The enzymes can be produced using recombinant microorganisms that have been engineered to express one or more saccharifying enzymes. For example, an H3A protein preparation that can be used for saccharification of pretreated lignocellulosic biomass is a crude preparation of enzymes produced by a genetically engineered strain of Trichoderma reesei, which includes a combination of cellulases and hemicellulases and is described in WO 2011/038019, which is incorporated herein by reference.

Chemical saccharification treatments can be used and are known to one skilled in the art, such as treatment with mineral acids including HCl and H₂SO₄ (U.S. Pat. No. 5,580,389: WO2011002660).

Sugars such as glucose, xylose and arabinose are released by saccharification of lignocellulosic biomass and these monomeric sugars provide a carbohydrate source for a biocatalyst used in a fermentation process. The sugars are present in a biomass hydrolysate that is used as fermentation medium. The fermentation medium can be composed solely of hydrolysate, or can include components additional to the hydrolysate such as sorbitol or mannitol at a final concentration of about 5 mM as described in U.S. Pat. No. 7,629,156, which is incorporated herein by reference. The biomass hydrolysate typically makes up at least about 50% of the fermentation medium. Typically about 10% of the final volume of fermentation broth is seed inoculum containing the biocatalyst.

The medium comprising hydrolysate is fermented in a fermenter, which is any vessel that holds the hydrolysate fermentation medium and at least one biocatalyst, and has valves, vents, and/or ports used in managing the fermentation process.

Any biocatalyst that produces a target product utilizing glucose and preferably also xylose, either naturally or through genetic engineering, may be used for fermentation of the fermentable sugars in the biomass hydrolysate made from lignocellulosic biomass. Target products that may be produced by fermentation include, for example, acids, alcohols, alkanes, alkenes, aromatics, aldehydes, ketones, biopolymers, proteins, peptides, amino acids, vitamins, antibiotics, and pharmaceuticals. Alcohols include, but are not limited to methanol, ethanol, propanol, isopropanol, butanol, ethylene glycol, propanediol, butanediol, glycerol, erythritol, xylitol, mannitol, and sorbitol. Acids may include acetic acid, formic acid, lactic acid, propionic acid, 3-hydroxypropionic acid, butyric acid, gluconic acid, itaconic acid, citric acid, succinic acid, 3-hydroxyproprionic acid, fumaric acid, maleic acid, and levulinic acid. Amino acids may include glutamic acid, aspartic acid, methionine, lysine, glycine, arginine, threonine, phenylalanine and tyrosine. Additional target products include methane, ethylene, acetone and industrial enzymes.

The fermentation of sugars in biomass hydrolysate to target products can be carried out by one or more appropriate biocatalysts, that are able to grow in medium containing biomass hydrolysate, in single or multistep fermentations. Biocatalysts may be microorganisms selected from bacteria, filamentous fungi and yeast. Biocatalysts can be wild type microorganisms or recombinant microorganisms, and can include, for example, organisms belonging to the genera of Escherichia, Zymomonas, Saccharomyces, Candida, Pichia, Streptomyces, Bacillus, Lactobacillus, and Clostridiuma. Typical examples of biocatalysts include recombinant Escherichia coli, Zymomonas mobilis, Bacillus stearothermophilus, Saccharomyces cerevisiae, Clostridia thermocellum, Thermoanaerobacterium saccharolyticum, and Pichia stipitis. To grow well and have high product production in a lignocellulosic biomass hydrolysate fermentation broth, a biocatalyst can be selected or engineered to have higher tolerance to inhibitors present in biomass hydrolysate such as acetate. For example, the biocatalyst may produce ethanol as a target product, such as production of ethanol by Zymomonas mobilis as described in U.S. Pat. No. 8,247,208, which is incorporated herein by reference.

Fermentation is carried out with conditions appropriate for the particular biocatalyst used. Adjustments can be made for conditions such as pH, temperature, oxygen content, and mixing. Conditions for fermentation of yeast and bacterial biocatalysts are well known in the art.

In addition, saccharification and fermentation may occur at the same time in the same vessel, called simultaneous saccharification and fermentation (SSF). In addition, partial saccharification may occur prior to a period of concurrent saccharification and fermentation in a process called HSF (hybrid saccharification and fermentation).

For large scale fermentations, typically a smaller culture (seed culture) of the biocatalyst is first grown. The seed culture is added to the fermentation medium as an inoculum typically in the range from about 2% to about 20% of the final volume.

Typically fermentation by the biocatalyst produces a fermentation broth containing the target product made by the biocatalyst. For example, in an ethanol process the fermentation broth may be a beer containing from about 6% to about 10% ethanol. In addition to target product, the fermentation broth contains water, solutes, and solids from the hydrolysate medium and from biocatalyst metabolism of sugars in the hydrolysate medium. Typically the target product is isolated from the fermentation broth producing a depleted broth, which can be called whole stillage. For example, when ethanol is the product, the broth is distilled, typically using a beer column, to generate an ethanol product stream and a whole stillage. Distillation can be using any conditions known to one skilled in the art including at atmospheric or reduced pressure. The distilled ethanol is further passed through a rectification column and molecular sieve to recover an ethanol product. The target product may alternatively be removed in a later step such as from a solid or liquid fraction after separation of fermentation broth.

Filter Cake Production from Llignocellulosic Biomass Fermentation

Filter cake is produced as a co-product from a lignocellulosic biomass fermentation process. Typically filter cake is made from whole stillage that remains after distillation of a volatile target product that can be separated from fermentation broth by distillation. In one embodiment, filter cake is produced during fermentation of a lignocellulosic biomass hydrolysate to produce an alcohol such as ethanol. During production of ethanol from lignocellulosic biomass, fermentation broth is distilled to recover ethanol. The fermentation broth is processed in a distillation column to separate the ethanol and some water from the solids and the bulk of the water. Ethanol goes overhead and the solids and water exit the bottom of the column and are called “whole stillage”. The high lignin-content solids in the whole stillage are separated from the liquid typically using a filter press. These solids are called filter cake (hereafter FC) and are then removed from the system. The liquid fraction is further processed by evaporation using a multi-effect, falling film evaporator system and the evaporated water is condensed and treated by anaerobic digestion. Removing the water from the liquid fraction produces high-solids, lignocellulosic syrup.

### Filter Cake Composition

The filter cake may be used wet, or it can be dried which is typically by air drying. The wet lignocellulosic filter cake composition contains from about 35% to about 65% moisture (can have about 35%, 40%, 45%, 50%, 55%, 60%, or 65% moisture based on the total moisture content of the filter cake), from about 20% to about 75% volatiles (can have about 20%, 25%, 30%, 35%, 40%, 45%, 50%, 55%, 60%, 65%, or 75% volatiles based on the total weight of the filter cake), from about 35% to about 65% solids (can have about 35%, 40%, 45%, 50%, 55%, 60%, or 65% solids based on the total weight of the filter cake), from about 1% to about 30% ash (can have about 1%, 3%, 5%, 10%, 15%, 20%, 25%, or 30% ash based on the total weight of the filter cake), from about 5% to about 20% fixed carbon, and it has an energy value of about 2,000 to about 9,000 BTU/lb (can have about 2,000, 2,500, 3,000, 3,500, 4,000, 4,500, 5,000, 5,500, 6,000, 6,500, 7,000, 7,500, 8,000, 8,500, or 9,000 BTU/lb). The volatile content is measured by establishing the loss in weight resulting from heating under rigidly controlled conditions to 950° C. (as described in ASTM D-3175). Typical volatiles include hydrogen, oxygen, nitrogen, acetic acid, and some carbon and sulfur. Ash is determined by weighing the residue remaining after burning under controlled conditions according to ASTM D-3174. The amount of fixed carbon is calculated by adding the percentages of moisture, ash, and volatiles, and then subtracting from 100. The full upper range of BTU/lb is typically achieved with drying. FC can be dried and/or processed, such as using a hammer mill, into particles prior to application herein.

For the practice of the instant disclosure, the FC obtained from fermentation of lignocellulosic biomass can be dried to reduce its moisture content from between about 40 wt % and about 60 wt %, to between about 0 and about 50 wt % based on the total weight of the FC. Alternatively, the moisture content of FC can be from about 0 wt % to about 40 wt % based on the total weight of the FC. Further, the moisture content of FC can be from about 0 wt % to about 20 wt % based on the total weight of the FC. In an embodiment of the instant disclosure the moisture content of FC is about 5% based on the total weight of the FC.

Reducing the amount of moisture in the FC can be achieved using methods well known to those experienced in the relevant art such as conventional ovens, microwave ovens, air dryers, etc. Alternatively, the FC can be left at ambient temperature (from about 15 to about 30° C.) to air dry.

### Plant Nutrients

Plant nutrients comprise macro- and micronutrients. As defined herein, primary macronutrients are nitrogen (N), phosphorous (P), and potassium (K). The macronutrients are important for plant growth and are used by plants in relatively large amounts in any combinations and proportions deemed suitable for each individual plant type, however, they are not always adequately available in natural soils to support the sustained growth of plants. Additionally, production of crops removes these vital macronutrients from the soil. Key macronutrients, such as nitrogen, which are essential to plant growth, will be readily removed from the soil by the production of crops.

Nitrogen for plants is provided primarily from urea, and to a lesser extent by the ammonium ion of the ammonium nitrate component. Nitrogen is vital for the formation of all new plant protoplasm. Chlorophyll is a nitrogen compound, and nitrogen is also heavily used by plants in forming stems and leaves. Blood, bone, or soybean meal or the dried residue of a manure or compost tea can also be used as substitute organic sources of nitrogen. Other nitrogen sources can include methylol urea, isobutylene urea, and/or ammonia. In one embodiment, plant nutrients in the present nutrient mixture contains urea in a concentration of from about 1% to about 99% based on the total weight of the components in the one or more plant nutrients.

Phosphorus is provided largely by calcium phosphate and diammonium phosphate. Plants require phosphorus for photosynthesis, energy transfers within plants, and for good flower and fruit growth. Powdered bone meal, phosphate rock, and phosphoric acid can also be used as sources of phosphorus. Potassium is provided largely by muriate of potash, and to a much lesser extent by seaweed. Potassium is used by plants in the manufacture and movement of sugars and in cell division. It is necessary for root development and helps plants to retain water. Other possible sources of phosphorus would be wood ashes, granite dust, potassium chloride, potassium nitrate, potassium sulfate, and potassium carbonate.

Micronutrients (also known as trace elements) suitable for plant growth in the instant process include, but are not limited to; calcium, magnesium, iron, manganese, sulfur, molybdenum, iodine, silicon, zinc, copper, boron, and combinations thereof. These micronutrients can be added either together with macronutrients or separately to FC for supporting growth of the plant.

Any of the nutrients listed above can be used alone or in combination with other nutrients and/or chemicals when preparing plant nutrients. The formulation and the ratio of the macro- and micronutrients in any given preparation are dictated by the specific target plant's requirements, as is known to one of skill in the art.

Additional materials that can function as fertilizers can be added to macronutrients to help plant growth. Examples of materials that can be used in the instant disclosure include, but are not limited to: vegetable waste and bio-degradable waste provided by natural bacteria, fungus and mechanical means and mixed with cattle-dung, animal skin, poultry farm manure, pressed mud of sugar mills, sericulture waste, coconut fibers, bone powder and volcanic rock granulized with the help of various bacterial cultures such as Azotobacter and Rhizobium and combinations thereof. Further, crop active chemicals such as pesticides, fungicides, herbicides, and the like, can be added to the mixture of the FC and the nutrients. Hereafter such materials and any other additional chemicals suitable for including with the plant nutrients and the FC are called “additives”.

The nature of one or more additives, to be included in the nutrient mixture, can be determined based on the needs of the crops or flowers at the time of application to the soil.

### The Nutrient Mixture

In one embodiment is a nutrient mixture composition comprising: i) one or more plant nutrients; ii) optionally one or more additives, deemed suitable for specific applications; and iii) FC. The nutrient mixture composition is prepared by contacting components (i) through (iii). Contacting to bring the components together can be performed using any method well known in the relevant art. For example, using a spatula, a blender, a hand held mixer, an agitator, a paddle mixer, or a high speed Vortex® mixer.

For use in the present plant nutrient matrix described below, the nutrient mixture composition contains at least about 25 wt % FC based on the total weight of the nutrient matrix composition. In various embodiments the nutrient mixture composition of the present plant nutrient matrix contains at least about 25%, 30%, 35%, 40%, 45%, 50%, 55%, 60%, 654%, 70%, 75%, or more of FC.

For use in the present plant nutrient matrix described below, the nutrient mixture composition contains at least about 25 wt % urea based on the total weight of the nutrient matrix composition. In various embodiments the nutrient mixture composition of the present plant nutrient matrix contains at least about 25%, 30%, 35%, 40%, 45%, 50%, 55%, 60%, 654%, 70%, 75%, or more of urea.

### The Nutrient Delivery System

Following preparation of the nutrient mixture composition, it is then formed into a nutrient delivery system. The nutrient delivery system can be formed using any methods described in the relevant art and known to one experienced in the art. For example, the nutrient delivery system can be prepared using methods such as: pressing, tableting, forming, molding, extrusion, compacting, pelleting, compression rolling and granulation. The nutrient delivery system may be any of beads, tablets, granules, pellets, pills and the like in any shape or form that can deliver nutrients to plants.

### The Plant Nutrient Matrix

Following preparation of the nutrient delivery system, in the practice of the instant disclosure, it is treated with at least one polymer to provide a plant nutrient matrix. Polymers useful for the instant disclosure include but are not limited to; polyesters, polyam ides, polyolefins, polysaccharides, polyethers, polyurethanes, polycarbonates, poly(alkyl methacrylate)s, poly(alkyl acrylate)s, poly(acrylic acids), poly(meth)acrylic acids, polyphosphazenes, polyim ides, polyanhydrides, polyamines, polydienes, polyacrylamides, poly(siloxanes), poly(vinyl alcohol), poly(vinyl esters), poly(vinyl ethers), poly(lactic acid), proteins, waxes, oils, greases poly(ethylene glycol), salts of poly(acrylic acid), poly(vinyl alcohol), natural rubber, polysulfones, and polysulfides. Specific polymers for use herein may include amorphous poly(D,L-lactic acid), poly(lactic acid), poly(L-lactic acid), poly(D-lactic acid), poly(meso-lactic acid), poly(rac-lactic acid), or poly(D, L-lactic acid), (poly(hydroxyalkanoate), poly(hydroxybutyrate), poly(hydroxybutyrate-co-valerate), poly(caprolactone), poly(butylene succinate), poly(butylene succinate adipate), poly(ethylene succinate), poly(ethylene carbonate), poly(propylene carbonate), starch, gelatin, thermoplastic starch, poly(butylene terephthalate adipate), poly(propylene terephthalate succinate), poly(propylene terephthalate adipate), poly(vinyl alcohol), poly(ethylene glycol), cellulose, chitosan, cellulose acetate, or cellulose butyrate acetate, soy wax, bees wax, and carnauba wax. Polymers of use herein may include natural polymers, block copolymers, water soluble polymers, and crosslinked polymers. Any of the polymers listed herein can be used in the practice of the instant disclosure either alone or in combination with other polymers.

In addition, the polymer used to treat the plant nutrient matrix may include components such as, but not limited to, plasticizers, antioxidants, nucleating agents, impact modifiers, processing aids, tougheners, colorants, fillers, stabilizers, and the like,

At least one layer of one or more polymers is applied by treating the nutrient delivery system to prepare the plant nutrient matrix. Treating is by any method that deposits a layer of one or more polymer onto the nutrient delivery system. The deposited layer is also called a treatment layer. Treating may include coating, wrapping, covering, layering, encrusting, sheathing, blanketing, and the like. Treating may include heating for a time sufficient to seal the layer around the nutrient delivery system. The plant nutrient matrix can be prepared by shrink wrapping the at least one layer of one or more polymers of choice around the delivery system using solvent or melt coating in a drum, fluid bed coating, or any other treatment method known in the art.

The plant nutrient matrix comprises an outer layer which is a treatment layer of the at least one polymer. The treatment layer may have a thickness of between about 10 and about 510 micrometers, between about 10 and about 55 micrometers, or between about 20 and about 110 micrometers. In one embodiment the treatment layer comprises a poly(lactic acid) polymer. In one embodiment the treatment layer comprises a poly(lactic acid) polymer and has a thickness of from about 10 to about 510 micrometers. Alternatively, the thickness of the treatment layer can be from 20 to 110 micrometers. Further, the thickness of the treatment layer can be from 10 to 55 micrometers. In an embodiment, the thickness of the treatment layer is a layer of poly(lactic)acid polymer of about 25.4 micrometers.

The polymer composition and its thickness can be adjusted to meet the needs of the crops or flowers at the time of application to the soil.

### Sustained Release of Nutrients

The plant nutrient matrix disclosed herein comprises FC, one or more plant nutrients and optionally one or more additives. FC which is a co-product of a lignocellulosic biomass fermentation process comprises various products of lignin and cellulose that can breakdown into humates, which due to their high cation exchange capacity, can prevent leaching of nutrients and retain them in the matrix for slow release to plants over time.

Conditions for sustained release of nutrients and optionally additives comprise contacting of the plant nutrient matrix with the soil wherein the moisture in the soil allows release of the nutrients and additives within said matrix.

Using this method has an additional advantage for the plants. Various components present in the humates released by the FC can also serve as a second source of nutrients for plants when the supply of the original plant nutrients is depleted.

The disclosed composition, process and method can be specifically useful for row crops, vegetables, turf, grass, and horticultural applications.

### EXAMPLES

The present invention is further defined in the following Examples. It should be understood that these Examples are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Abbreviations

The meaning of abbreviations used is as follows: “s” is second, “min” means minute(s), “h” or “hr” means hour(s), “μL” or “μl” means microliter(s), “mL” or “ml” means milliliter(s), “L” or “l” means liter(s), “m” is meter, “nm” means nanometer(s), “mm” means millimeter(s), “cm” means centimeter(s), “μm” means micrometer(s), “mM” means millimolar, “M” means molar, “mmol” means millimole(s), “μmole” means micromole(s), “g” means gram(s), “μg” means microgram(s), “mg” means milligram(s), “kg” is kilogram, “rpm” means revolutions per minute, “C” is Centigrade, “ppm” means parts per million, “cP” is centipoise, “g/l” means grams per liter, “SSU” is Saybolt Universal Viscosity in Seconds;

### General Methods

### Analysis of Urea

A BioAssay Systems QuantiChrom™ Urea Assay Kit (DIUR-500) was used for quantitative colorimetric urea determination. A 0.2 M aqueous urea stock solution was used to make standard solutions for the standard curve. A similar standard curve was prepared for use with soil extraction samples with the diluent being one molar Tris buffer solution at pH 9. The working reagent was prepared by mixing Reagent A and Reagent B immediately before carrying out the assay.

5 μL samples were added into a 96-well plate and 200 μL of the working reagent was added to each sample. The 96 well tray was incubated at room temperature for 20 minutes before analysis using a spectrophotometer (BioTek™ PowerWave™ XS Spectrophotometer-PowerWave XS2, 100 Tigan St., Winooski, Vt. 05404, USA).

### Suppliers

Hydraualic press was from Preco Hydraulic Press, Model PA2-1, S/N 1943,9705 Commerce Parkway, Lenexa, Kans. 66219, USA.

The poly(lactic acid) was from Ingeo 4032D, Natureworks LLC, Minnetonka, Minn. USA.

Urea concentration was determined using the kit obtained from BioAssay Systems, Hayward, Calif. , USA.

### EXAMPLE 1

### Release of Urea from a Plant Nutrient Matrix

In this example, the effect of FC on release of urea was studied. Three different compositions were prepared by mixing: urea 25% and FC 75%; urea 50% and FC 50%; urea 75% and FC 25%, all based on the total weight of the components. Both materials were ground using a mortar and pestle before the fabrication of the pellet. The final weight of the urea/FC in each sample was 4 grams. These samples were prepared into separate pellets, as nutrient delivery systems, using a hydraulic press at 20,000 lbs of force. The nutrient delivery systems were then each wrapped in one layer of 25.4 micrometer poly(lactic acid) to provide a plant nutrient matrix and were then heated with a heat gun for 5 seconds to seal the layer around the nutrient delivery system.

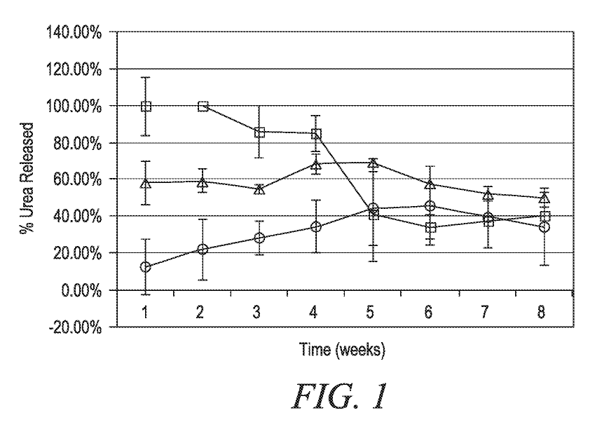

Water release profiles of these nutrient matrix samples were measured by placing each matrix in 250 mL of water in a jar on a table top shaker either at 15° C. or at 30° C. at a speed of 45 rpm. The concentration of urea in the solution was measured weekly. The release profile of each composition was measured at 15° C. and 30° C. in triplicates. The results at 30° C. that are shown in FIG. 1 indicated that the release rate of urea decreased with higher loadings of filter cake. The urea release profiles of samples treated at 15° C. and those treated at 30° C. were similar. Thus, urea release was not affected by the change in the temperature. After about 4 weeks, the concentration of urea in the water decreased due to its hydrolysis. The FC swelled during the experiment causing the polymer layer to break open and release the remaining contents and FC into the water.

1. A nutrient delivery system composition comprising:
a) lignocellulosic filter cake;
b) one or more plant nutrients; and
c) optionally one or more additives.

2. The composition of claim 1, wherein the lignocellulosic filter cake is a co-product of a lignocellulosic biomass fermentation process.

3. (canceled)

4. The composition of claim 1 wherein the filter cake of (a) is at least about 25 wt % of the nutrient mixture based on the total weight of the nutrient mixture.

5. (canceled)

6. The composition of claim 1, wherein the one or more plant nutrients is selected from the group consisting of nitrogen (N), phosphorous (P), potassium (K), and mixtures thereof.

7. The composition of claim 6, wherein the nitrogen is in the form of urea.

8. The composition of claim 7, wherein the urea has a concentration of from about 1% to about 99% based on the total weight of the components in the one or more plant nutrients.

9. The composition of claim 7 wherein the urea is at least about 25 wt % of the nutrient mixture based on the total weight of the nutrient mixture.

10. (canceled)

11. The composition of claim 1, further taking the form selected from the group consisting of beads, tablets, granules, pellets, pills, and mixtures thereof, forming a nutrient delivery system.

12. The composition of claim 11, wherein the nutrient delivery system further comprises at least one polymer forming a plant nutrient matrix.

13. The composition of claim 12, wherein the polymer is selected from the group consisting of polyester, polyamide, polyolefin, polysaccharide, polyether, polyurethane, polycarbonate, poly(alkyl methacrylate), poly(alkyl acrylate), poly(acrylic acid), poly(meth)acrylic acid, polyphosphazene, polyimide, polyanhydride, polyamine, polydiene, polyacrylamide, poly(siloxane), poly(vinyl alcohol), poly(vinyl ester), poly(vinyl ether), poly(lactic acid), natural polymer, block copolymer, crosslinked polymer, protein, wax, oil, grease, water soluble polymer, poly(ethylene glycol), salt of poly(acrylic acid), poly(vinyl alcohol), natural rubber, polysulfone, polysulfide, amorphous poly(D,L-lactic acid), poly(lactic acid), poly(L-lactic acid), poly(D-lactic acid), poly(meso-lactic acid), poly(rac-lactic acid), poly(D,L-lactic acid), (poly(hydroxyalkanoate), poly(hydroxybutyrate), poly(hydroxybutyrate-co-valerate), poly(caprolactone), poly(butylene succinate), poly(butylene succinate adipate), poly(ethylene succinate), poly(ethylene carbonate), poly(propylene carbonate), starch, gelatin, thermoplastic starch, poly(butylene terephthalate adipate), poly(propylene terephthalate succinate), poly(propylene terephthalate adipate), poly(vinyl alcohol), poly(ethylene glycol), cellulose, chitosan, cellulose acetate, cellulose butyrate acetate, soy wax, bees wax, carnauba wax and mixtures thereof.

14. The composition of claim 13, wherein the polymer is a poly(lactic acid) polymer.

15. The composition of claim 12, wherein the at least one polymer forms an outer treatment layer of the plant nutrient matrix.

16. The composition of claim 15, wherein the thickness of the treatment layer is between about 10 and about 510 micrometers.

17. (canceled)

18. A process for providing a nutrient delivery system comprising:
a) contacting lignocellulosic filter cake, one or more plant nutrients, and optionally, one or more additives, wherein a nutrient mixture is prepared; and
b) forming the nutrient mixture into a shape or form that can deliver nutrients to plants, wherein a nutrient delivery system is prepared.

19. The process of claim 18, further comprising treating the nutrient delivery system with a polymer to form a plant nutrient matrix.

20-21. (canceled)

22. The process of claim 18 or 19 wherein the filter cake of (a) is at least about 25 wt % of the nutrient mixture based on the total weight of the nutrient mixture.

23. (canceled)

24. The process of claim 18, wherein the one or more plant nutrients is selected from the group consisting of nitrogen (N), phosphorous (P), potassium (K), and mixtures thereof.

25. The process of claim 24, wherein the nitrogen is in the form of urea.

26-28. (canceled)

29. The process of claim 18, wherein the one or more plant nutrients comprises at least one micronutrient selected from the group consisting of magnesium, iron, manganese, sulfur, molybdenum, iodine, silicon, zinc, copper, boron and combinations thereof.

30. A process of providing sustained release of plant nutrients in the soil comprising:
a) providing the plant nutrient matrix of claim 12;
b) adding said plant nutrient matrix to soil under conditions whereby sustained release of nutrients over time is provided.
